(19) United States
(12) Patent Application Publication
(10) Pub. No.: US 2012/0247256 A1
(43) Pub. Date: Oct. 4, 2012

(54) SHIFTING CONTROL

(75) Inventors: Olaf HELDMANN, Buettelborn (DE); Andreas WAGNER, Darmstadt (DE)

(73) Assignee: GM GLOBAL TECHNOLOGY OPERATIONS LLC, Detroit, MI (US)

(21) Appl. No.: 13/421,953

(22) Filed: Mar. 16, 2012

(30) Foreign Application Priority Data
Mar. 16, 2011 (DE) 10 2011 014 071.9

(51) Int. Cl. B60K 20/02

(52) U.S. Cl. 74/473.29

(57) ABSTRACT

A shifting control is provided for a manual transmission of a motor vehicle having a shifting shaft, on which a shifting shaft lever for rotating the shifting shaft is rotationally fixed. A shifting mass is connected to an actuation end of the shifting shaft lever in a relatively moveable manner via an elastic element, so that the shifting mass and the elastic element form a vibration absorber.

### CROSS-REFERENCE TO RELATED APPLICATION

This application claims priority to German Patent Application No. 10 2011 014 071.9, filed Mar. 16, 2011, which is incorporated herein by reference in its entirety.

### TECHNICAL FIELD

The technical field relates to a shifting control for a manual transmission, and more particularly to an internal shifting control for installation in a manual transmission, which can be employed for motor vehicles having a combustion engine.

### BACKGROUND

For shifting the gears of a motor vehicle the driver actuates an external shifting control or a gear selector lever in the vehicle interior, which is connected to the internal shifting control for the transmission via two shifting cables. On actuating the external shifting control the shifting cables are pulled as a result of which parts of the internal shifting control are vertically moved or rotated, as a result of which through an operational connection with the transmission the gears are subsequently selected and engaged. In the following, shifting control is to always mean the internal shifting control, unless otherwise stated. Owing to manufacturing tolerances, vibrations in the transmission can be transmitted to the external shifting control via the internal shifting control and the shifting cables, which worsens the user comfort.

At least one object is to provide an internal shifting control with which an improved shifting comfort is achieved. In addition, other objects, desirable features, and characteristics will become apparent from the subsequent summary and detailed description, and the appended claims, taken in conjunction with the accompanying drawings and this background.

### SUMMARY

An embodiment describes a shifting control for a manual transmission of a motor vehicle. The shifting control can be arranged in a transmission housing in order to shift transmission gears. The shifting control comprises a shifting shaft on which a shifting shaft lever for rotating the shifting shaft is rotationally fixed. Furthermore, a shifting mass is connected to an actuation end of the shifting shaft lever in a relatively moveable manner via an elastic element.

Physically, two vibrating masses coupled to each other are present with this design, namely on the one hand the vibrating shifting shaft and on the other hand the relatively moveable shifting mass. Altogether the shifting shaft vibrates with reduced amplitude. Insofar, the shifting mass and elastic element form a vibration absorber.

Through the relatively moveable connection of the shifting mass to the actuation end of the shifting shaft lever, rotary vibrations or vibrations originating from the transmission are merely transmitted to the external shifting control in a dampened manner or with reduced vibration amplitude. Since the external shifting control, also called gear selector lever, is operated by the driver, the relatively moveable connection results in fewer haptically perceptible vibrations and moreover in more shifting comfort.

A configuration of the shifting control provides that the elastic element is a spring system or alternatively a rubber body, for example a rubber cylinder. With the first version, for example in the shape of an individual spring, in particular a coil spring, the natural frequency of the vibration absorber is clearly defined that allows it to efficiently absorb resonances of the transmission that can be closely defined in terms of frequency. The choice of a rubber body by contrast results in a broader-band vibration damping, which is suitably practical when the transmission, with which the shifting control interacts, displays broader-band vibrations in operation. A broader-band damping however is also achieved if the spring system comprises two or more springs for example arranged parallel to one another with different spring constants. In all cases, the size of the shifting mass and the dynamic stiffness of the vibration absorber will be selected so that the shifting mass vibrates phase-shifted to the shifting shaft and a transmission of such vibrations to the gear shift lever is thus diminished. Thus, complicated end pieces, for example in the case of cable shifts, and additional weights on mechanical transitions and joints can be omitted. At the same time, the driver is imparted a greater preciseness of the shifting feeling since no perceptible vibrations can occur on the gear shift lever in the interior of the vehicle any longer and a convincing ease of movement of the shift is perceptible.

During experimental investigations it has been determined that the vibration absorber is best designed for engine rotational speeds of approximately 2,000 to approximately 3,000 rpm, i.e. taking into account the gear pairing in the engaged gear for rotational vibrations of the shifting shaft in the range from approximately 30 Hz to approximately 50 Hz, which naturally is identical to the natural frequency of the vibration absorber.

In an embodiment, a guide element is provided that is fixed to the shifting shaft for holding and if required also slide-displaceable guiding of the shifting mass. In a further embodiment, the guide element is connected to the actuation end of the shifting shaft lever. The shifting mass consequently has no direct mechanical articulation on the actuation end of the shifting shaft lever, but an end of the elastic element is connected to the actuation end of the shifting shaft lever for example in an articulated manner and an opposite end of the elastic element is connected to the shifting mass that is arranged on the guide rail in a slide-displaceable manner. Such an elastic element can be torsionally loaded.

The guide element carries the shifting mass and in a further embodiment is rigidly connected to the actuation end of the shifting shaft lever. In this case, the entire guide element with shifting mass is likewise pivoted in the case of a pivot movement of the shifting shaft lever. Alternatively, the guide element is rigidly connected to the transmission housing. In this case, the shifting shaft lever is not loaded by the weight of the guide element and merely the vibration absorber acts on the actuation end of the shifting shaft lever.

Furthermore, it can be provided that the guide element comprises a telescopic guide with at least one outer and one inner telescopic element. The outer and the inner telescopic element are slide-displaceably interconnected and form a telescope unit having an angular cross section it is simultaneously ensured that the shifting mass during the slide displacement cannot rotate. In the case of tubular telescopic elements, a second telescope unit which is aligned parallel to the first telescope unit is preferentially employed as guide element in order to form a rotation-proof guidance of the shifting mass. Here, an end each of a telescope unit is connected to the actuation end of the shifting shaft lever, while the second end of the telescope unit is connected to the shifting mass.

The elastic element, which for a vibration absorber constitutes the connection between the actuation end of the shifting shaft lever and the shifting mass itself can be arranged either parallel to such a telescope unit or be located within the telescope unit. An arrangement within the telescope unit has the advantage that the elastic element is protected from damages. Instead of telescope units, a guide rail can also be provided as guiding element. The guide rail to this end can comprise a sliding plate which can slide to and fro within the guide rail, wherein the shifting mass is fixed on the sliding plate mounted in a slide-displaceable manner. To this end, a dovetail profile of the guide rail is advantageous.

Such a manual transmission is preferentially employed as motor vehicle transmission, wherein the motor vehicle transmission is provided in the drive train of a motor vehicle with a combustion engine. It is provided, furthermore, that the guide element comprises a stop for limiting the deflection of the elastic element of the vibration absorber in order to prevent that the elastic element is overloaded or overstretched.

### BRIEF DESCRIPTION OF THE DRAWINGS

The present invention will hereinafter be described in conjunction with the following drawing figures, wherein like numerals denote like elements, and:

FIG. 1 shows a schematic perspective view of a geodetic upper end of a shifting shaft, on which a vibration absorber according to a first embodiment;

FIG. 2 shows a schematic perspective view of a geodetic upper end of a shifting shaft, to which a vibration absorber according to a second embodiment is welded; and

FIG. 3 shows a perspective top view of a geodetic upper end of a shifting shaft with a vibration absorber according to a third embodiment.

### DETAILED DESCRIPTION

The following detailed description is merely exemplary in nature and is not intended to limit application and uses. Furthermore, there is no intention to be bound by any theory presented in the preceding background or summary or the following detailed description.

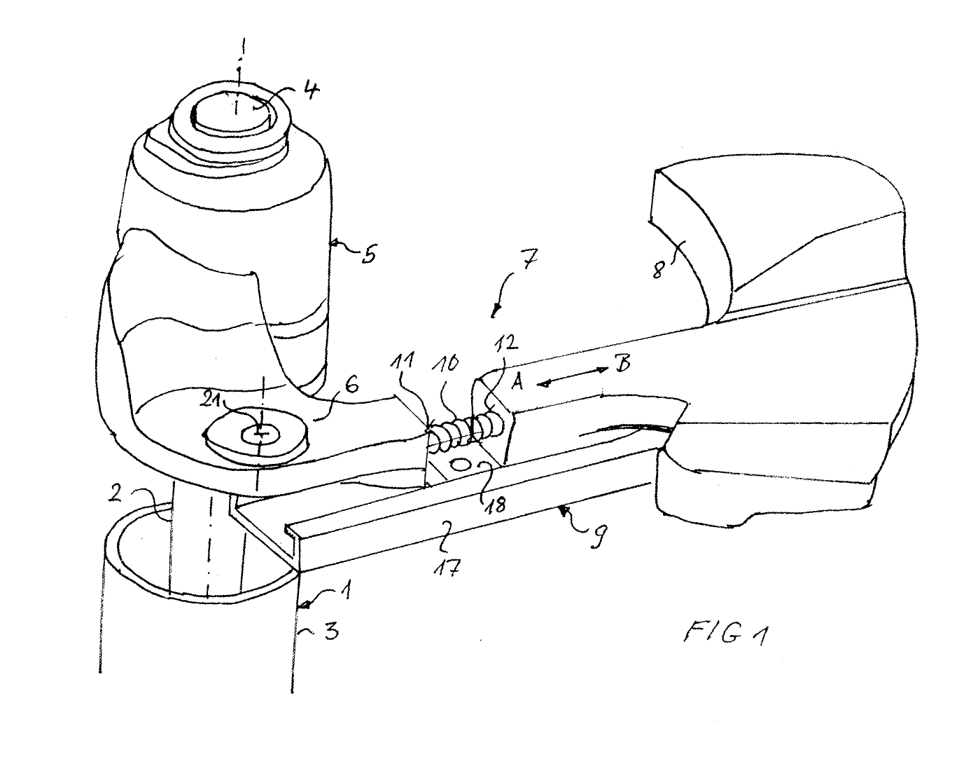

FIG. 1 schematically shows an end 4 of a shifting shaft 2 of a manual transmission 1. On the end 4, a vibration absorber 7 is articulated according to a first embodiment. On the end 4 of the shifting shaft 2 a shifting shaft lever 5 is arranged in a rotationally fixed manner, which at an actuation end 6 comprises an actuation opening 21, with which a shifting cable end that is not shown can be connected in an articulated manner. On the actuation end 6, a first end 11 of an elastic element 10 of the vibration absorber 7 is additionally fixed. A shifting mass 8 is connected to a second end 12 of the elastic element 10.

The shifting mass 8 is slide-displaceably arranged on a guide element 9. The guide element 9 comprises a guide rail 17, which is rigidly connected to a transmission housing 3, from which the shifting shaft 2 protrudes. Furthermore, the guide element 9 comprises a sliding plate 18, which is slide-displaceably arranged in the profile of the guide rail 17 and carries the shifting mass 8. To this end, the guide rail 17 can comprise a slit rectangular profile as in FIG. 1 or a dovetail profile. The guide element that is rigidly connected to the transmission housing 3 ensures that the shifting mass 8 can merely vibrate linearly in the arrow directions A and B.

The linear movement of the vibration absorber 7 is face-shifted to exciting vibrations of the manual transmission, which are transmitted via the shifting shaft and the shifting shaft lever, so that such vibrations are partially or completely absorbed by the vibration absorber 7 vibrating in a counter-phase manner and no longer reach the gear shift lever in the vehicle interior. Because of this face shift, the vibrations are no longer perceptible to the vehicle driver more so since these are no longer transmitted to the connecting mechanics to a gear shift lever arranged in the vehicle interior.

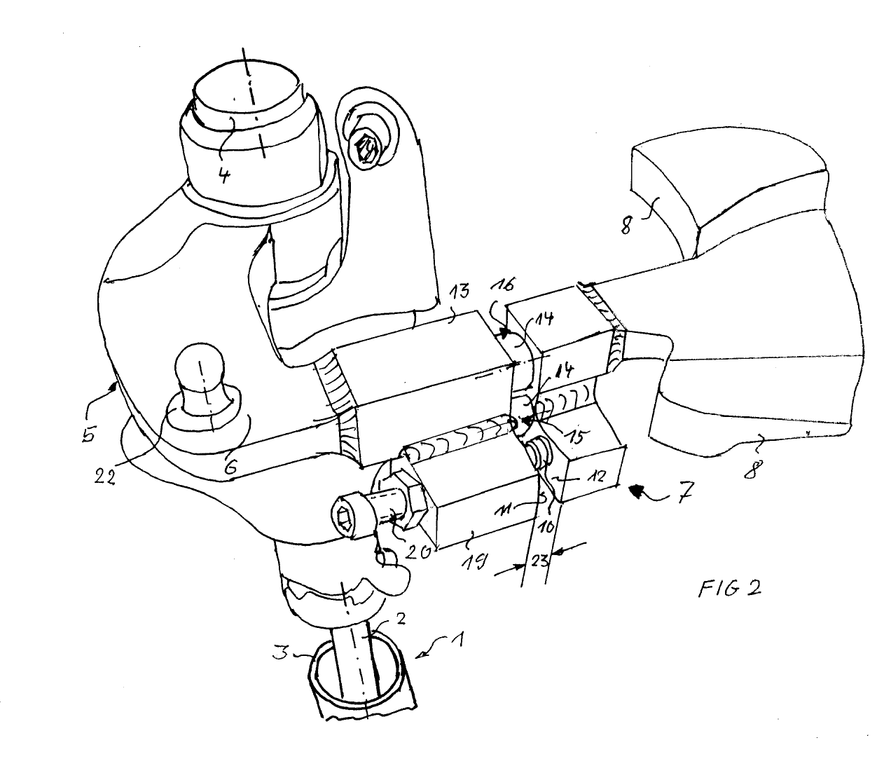

FIG. 2 shows a schematic view of an end 4 of a shifting shaft 2, on which a shifting shaft lever 5 is rotationally fixed, which comprises an actuation end 6. On the actuation end 6 an actuation connection 22 in the shape of a ball joint is arranged, which interacts with an end of a mechanical connection to a gear shift lever arranged in a vehicle. A vibration absorber 7 is additionally welded to the actuation end 6 of the shaft lever 5, so that the vibration absorber 7 is rigidly connected to the actuation end 6.

The vibration absorber 7 comprises a shifting mass 8, which is slide-displaceably fixed in a guide element 9. The guide element 9 in this second embodiment consists of two tubular telescope units 15 and 16, which ensure a parallel guidance of the shifting mass 8, so that the shifting mass 8 can vibrate in a rotationally locked and linearly guided manner. To this end, the telescope units 15 and 16 each comprise an outer telescopic element 13 in the form of a block having a receiving bore for a tubular inner telescopic element 14. In this embodiment, the elastic element 10 is arranged parallel to the two telescope units 15 and 16, the deflection travel 23 of which is limited by a locking element 19 comprising an adjusting screw 20, with which the deflection travel 23 is adjustable.

The difference of this embodiment to the embodiment according to FIG. 1, substantially in this case, the guide element 9 in the form of a telescopic parallel guide is welded to the shifting shaft lever 5 and thus rigidly connected to the latter, so that upon pivot movements of the shifting shaft lever 5 the entire vibration absorber co-pivots.

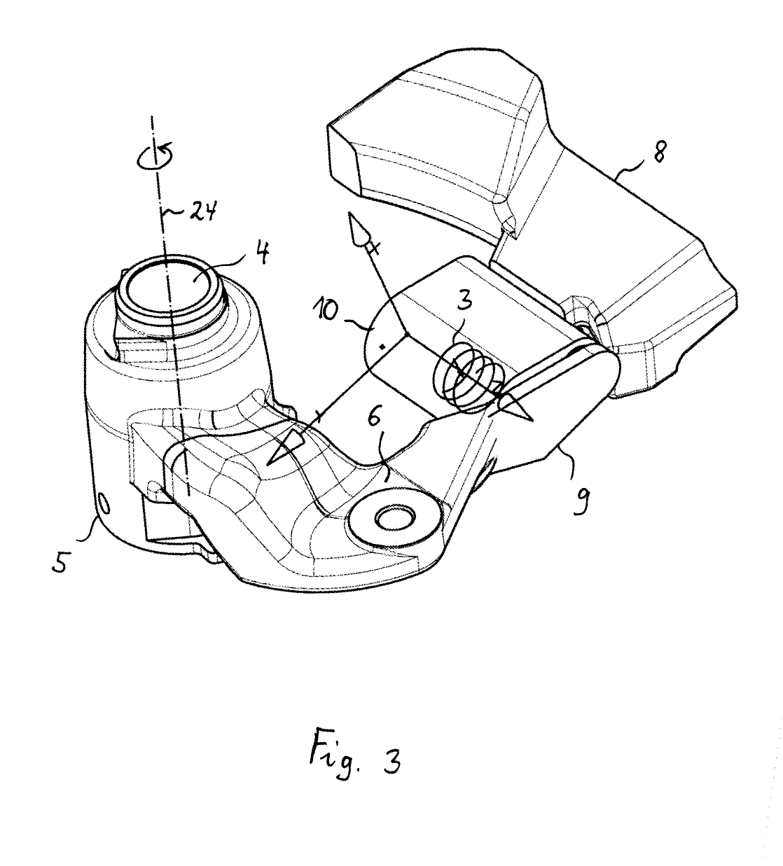

FIG. 3 shows an end 4 of a shifting shaft with a shifting mass 8. With this embodiment, with which same reference characters stand for same components as for the embodiments described at the outset, a guide element 9 formed unitarily with the shifting shaft lever 5 is now available in deviation from the former. The shifting mass 8 is rigidly connected to the elastic element 10 and the latter spring-elastically to the guide element 9. Upon rotary vibrations of the shaft lever 5 about its axis 24, the spring system, symbolically represented as a coil spring here, is alternatingly compressed in Z-direction or the spring system relaxes. Obviously, a rubber body, for example a rubber cylinder, can again be employed here instead of the spring system.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A shifting control for a manual transmission of a motor vehicle, comprising:
a shifting shaft on which a shifting shaft lever is configured to rotate the shifting shaft and rotationally fixed; and
a shifting mass is connected in a relatively moveable manner to an actuation end of the shifting shaft lever via an elastic element so that the shifting mass and the elastic element are configured to form a vibration absorber.

2. The shifting control according to claim 1, wherein the elastic element is a spring system.

3. The shifting control according to claim 1, wherein the elastic element is a rubber element.

4. The shifting control according to claim 1, wherein a natural frequency of the vibration absorber is in a range of approximately 30 Hz to approximately 50 Hz.

5. The shifting control according to claim 1, further comprising a guide element that is fixed to the shifting shaft and configured to hold, and if applicable, slide-displaceable guiding of the shifting shaft.

6. The shifting control according to claim 5, wherein the guide element is connected to the actuation end of the shifting shaft lever.

7. The shifting control according to claim 5, wherein the guide element is connected to the actuation end of the shifting shaft lever in an articulated manner.

8. The shifting control according to claim 5,
wherein the guide element is a telescopic guide with an outer and an inner telescopic element, and
wherein the outer and the inner telescopic element are interconnected in a slide-displaceable manner

9. The shifting control according to claim 7,
wherein the guide element comprises at least two telescopic guides that are substantially parallel to each other, and
wherein the elastic element is arranged substantially parallel to the at least two telescopic guides.

10. The shifting control according to claim 5, wherein the guide element comprises a guide rail.

11. The shifting control according to claim 10,
wherein the guide rail comprises a sliding plate that is slide-displaceably mounted in the guide rail, and
wherein the shifting mass is fixed on the sliding plate.

12. The shifting control according to claim 5, wherein the guide element comprises a stop that is configured to limit a deflection of the elastic element of the vibration absorber.
